(19) United States
(12) Patent Application Publication
(10) Pub. No.: US 2025/0256609 A1
(43) Pub. Date: Aug. 14, 2025

(54) Electric Vehicle Charger Pass-Through Adapter

(71) Applicant: Vivint LLC, Provo, UT (US)

(72) Inventor: Blake Lee, Provo, UT (US)

(73) Assignee: Vivint LLC, Provo, UT (US)

(21) Appl. No.: 19/049,092

(22) Filed: Feb. 10, 2025

Related U.S. Application Data
(60) Provisional application No. 63/552,037, filed on Feb. 9, 2024.

(51) Int. Cl. B60L 53/64; B60L 53/16; B60L 53/18; B60L 53/30; B60L 53/62; B60L 53/63; B60L 53/66; G06Q 50/06

(52) U.S. Cl. CPC B60L 53/64; B60L 53/16; B60L 53/30; B60L 53/62; B60L 53/63; B60L 53/665; B60L 53/18; G06Q 50/06

(57) ABSTRACT

An electric vehicle charger adapter may be configured to be controlled by a remote device in response to receiving a notification that high-electricity demand on an electricity power grid as measured by an energy provider. The notification may be communicated to a cloud server, mobile app, hub of an alarm system, and/or otherwise, and a notification or command may be communicated to the adapter for altering charging of an electric vehicle (EV). The charging alteration may be performed by reducing or stopping charging of a rechargeable battery of the EV.

### CROSS REFERENCE

This application claims priority to U.S. Provisional Patent Application, 63/552,037, filed Feb. 9, 2024, and entitled ELECTRIC VEHICLE CHARGER PASS-THROUGH ADAPTER, which is incorporated by reference herein in its entirety.

### TECHNICAL FIELD

The current disclosure generally relates to an electric vehicle (EV) charger.

### BACKGROUND

Electricity prices vary for a number of reasons, such as energy source price variations, delivery system price variations, weather changes, and energy demand from loads, such as homes and businesses, just to name a few. Peak power consumption by consumers of electricity on an electric energy grid increases cost for both consumers and the electric energy provider.

In addition to homes, as a result of electric vehicles becoming more popular, energy consumption has further increased. Electricity to recharge electric batteries for the EVs is significant and collectively add significant load to an electric energy grid. As such, there is a need to manage energy load by consumers, including those with EVs, to be better able to manage peak loads on an electric energy grid.

### SUMMARY

To enable a reduction in energy load by consumers with EVs, the principles provide for an electric vehicle charger adapter configured to be plugged into an outlet and be controllable by a user to reduce or stop electrical power from being supplied to an EV being charged by the adapter in response to high load power being drawn on an electrical power grid. In an embodiment, the user may utilize a mobile app on a mobile device (e.g., smartphone, hub configured to support an alarm system, etc.) to control operation of the adapter, thereby enabling a user to dynamically alter electrical power supply to the EV.

One embodiment of an electric vehicle charger adapter may include a housing and electronics disposed within the housing. A high-voltage electrical switch may be in electrical communication with the electronics, and be configured to switch between an ON state and an OFF state in response to a control signal output by the electronics to the electrical switch. At least one electrical connector may be connected to the housing and adapted to be plugged into respective at least one reciprocal power outlet. The electrical connector(s) may be in electrical communication with a first side of the electrical switch. An electrical cable electrically may be connected to a second side of the electrical switch, and a charging plug may be physically and electrically connected to the electrical cable. The charging plug may be adapted to be plugged into a charging socket of an electric vehicle (EV).

One embodiment of a method of manufacturing an electric vehicle charger adapter may include positioning electronics within a housing and electrically connecting a high-voltage electrical switch with the electronics. The high-voltage electrical switch may be configured to switch between an ON state and an OFF state in response to a control signal output by the electronics to the electrical switch. At least one electrical connector may be connected to the housing. The electrical connector(s) may be adapted to be plugged into respective at least one reciprocal power outlet. The electrical connector may be electrically connected with a first side of the electrical switch. An electrical cable may be electrically connected to a second side of the electrical switch. In being electrically connected, a direct or indirect connection (e.g., via another electrical component, such as a variable resistor or potentiometer) may be made. A charging plug may be physically and electrically connecting to the electrical cable, and the charging plug may be adapted to be plugged into a charging socket of an electric vehicle.

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is an illustration of an illustrative house with an electric vehicle (EV) plugged into an outlet within a garage of the house;

FIG. 2 is an illustration of an illustrative electric vehicle charger adapter that may be used to power an EV;

FIGS. 3A and 3B are illustrations of two types of illustrative electrical outlets that may be utilized in supplying electrical power to an EV via the adapter of FIG. 2;

FIG. 4 is a schematic of an illustrative electric vehicle charger adapter;

FIGS. 5A and 5B are illustrations of an illustrative user interface that enables a user to set up automatic control by the adapter via a mobile app (FIG. 5A) and semi-automatic control by the adapter via the mobile app (FIG. 5B);

FIGS. 6A and 6B are illustrations of illustrative user interfaces that enables a user to submit how much or a maximum amount of money to spend in charging a rechargeable battery of an EV (FIG. 6A) and/or what percentage of charge to charge the rechargeable battery (FIG. 6B).

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

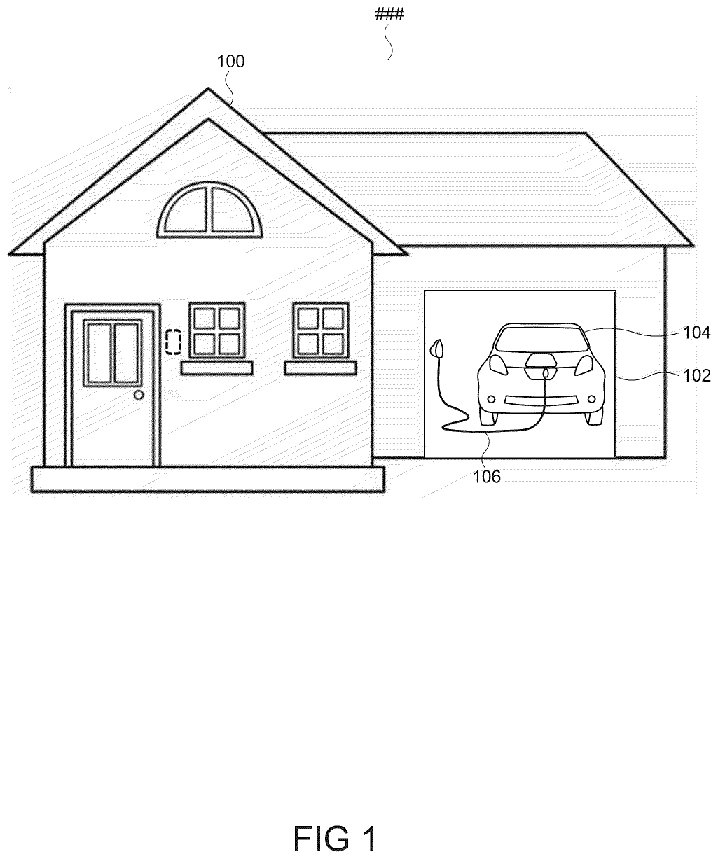

With regard to FIG. 1, an illustration of an illustrative building 100, in this case a house, including a garage 102 in which an electric vehicle (EV) 104 is stored and being charged is shown. The EV may be charged with an electric vehicle charger adapter 106 that is configured to be plugged into an electrical outlet and socket of the EV 104 for charging thereof. The electrical outlet may be 240V, 120V, or other voltage rating outlet that may be used for charging the EV. The adapter 106 may be configured with one or more electrical connectors, optionally interchangeable or configured with multiple electrical connectors. By using an adapter 106, the adapter 106 may be taken by the user with the EV 104 for using in other physical locations as opposed to having the socket configured with a cable to plug into the EV. Because the EV 104 may be charged at different buildings in which high electricity loads may be occurring, the adapter 106 may include electronics, including a high-power switch and a radio (e.g., WiFi®, cellular, Bluetooth, etc.), and be configured to be in communication with an electronic device, such as a mobile phone, hub of an alarm system, cloud server, or other electronic device, via the radio. The electronic device may be configured to set parameters or provide control signals that cause the adapter to reduce or stop electricity from being drawn by the EV 104, as further described herein.

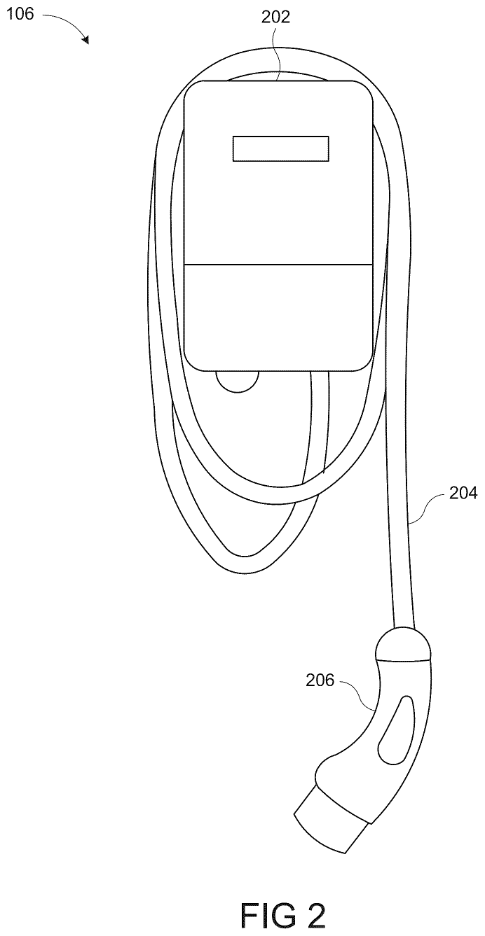

With regard to FIG. 2, an illustration of an illustrative electric vehicle charger adapter 106 that may be used to power an EV 104 is shown. The adapter 106 may include a housing 202, electronics disposed within the housing 202, a high-voltage electrical switch in electrical communication with the electronics. The electrical switch may be configured to switch between an ON state and an OFF state in response to a control signal output by the electronics to the electrical switch. At least one electrical connector may be connected to the housing 202 and be adapted to be plugged into respective at least one reciprocal power outlet. The electrical connector may be in electrical communication with a first side of the electrical switch. An electrical cable 204 may be electrically connected to a second side of the electrical switch. A charging plug 206 may be physically and electrically connected to the electrical cable 204 and adapted to be plugged into a charging socket of an electric vehicle 104.

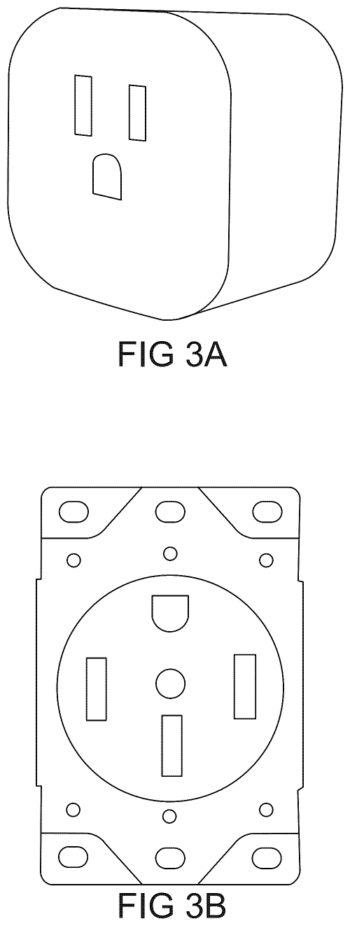

With regard to FIGS. 3A and 3B, illustrations of two types of illustrative electrical outlets that may be utilized in supplying electrical power to an EV via the adapter of FIG. 2 is shown. The adapter may include one or more electrical connectors or plugs that are configured to be plugged into the sockets of the electrical outlets. In an embodiment, the adapter may support swapping electrical connectors by a user or include two or more types of electrical connectors so that the user may select which of the electrical connectors to use when charging the EV.

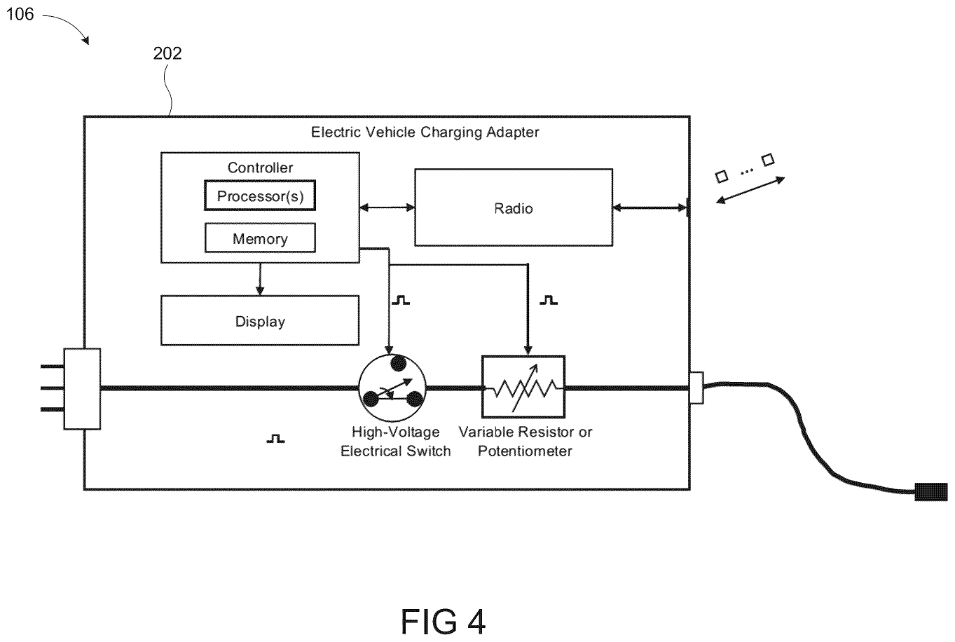

With regard to FIG. 4, a schematic of an illustrative electric vehicle charger adapter 106 is shown. The adapter 106 may include a housing 202 and electronics positioned in the housing 202. The electronics may include a controller that includes at least one processor configured to control operation of the adapter. For example, the processor(s) may be configured to reduce or stop electricity from being output from the adapter. The controller may further include a non-transitory memory that enables storage of data, such as one or more parameter that may be used to control operation of the adapter. For example, the parameter(s) may include a high electric power demand level that automatically or semi-automatically causes the controller to alter operation of the adapter (e.g., reduce or stop electricity from being output by the adapter). The memory may further be configured to store one or more network addresses, such as a network address of a cloud server that serves data to and from an electronic device, such as a mobile phone (e.g., smart phone), computer via a website, hub of an alarm system, etc. Additionally, the network address may include a local hub of an alarm system.

A high-voltage electrical switch may be in electrical communication with the electronics and configured to switch between an ON state and an OFF state in response to a control signal output by the electronics to the electrical switch. For example, the processor(s) may be configured to change a variable resistor (not shown) or transition the switch from an ON state to an OFF state by communicating a control signal to transition the electrical switch. An electronic display may be in communication with the controller.

At least one electrical connector connected to the housing and adapted to be plugged into respective at least one reciprocal power outlet. The electrical connector(s) may be in electrical communication with a first side of the electrical switch. An electrical cable may be electrically connected to a second side of the electrical switch. In an embodiment, the electrical cable may be permanently electrically connected to the second side of the electrical switch or may be removably attached to the adapter using a connector at the adapter end of the cable that attached to a reciprocal connector attached to the housing. A charging plug may be physically and electrically connected to the electrical cable and adapted to be plugged into a charging socket of an electric vehicle (EV).

In an embodiment, the electronics may further include a radio configured to wirelessly communicate with a local area network (LAN). The LAN may be a Wi-Fi communications network, and the electronics may further be configured to communicate with a hub of an alarm system locally positioned at a residence at which the electrical outlet is located. The electronics may additionally or alternatively include a radio configured to wirelessly communicate with a wide area network (WAN). The electronics may be configured to sense electrical power being drawn from the EV and communicate data indicative of the amount of electrical power being drawn to an electronic device via the WAN. The electronics may be configured to reduce or stop electrical power being drawn by the EV in response to a command received from an electronic device via the WAN. To reduce the amount of electrical power, a variable resistor or potentiometer may be included as part of the adapter. To stop the electrical power, a high-voltage electrical switch may be provided. Control of either or both of the variable resistor (or potentiometer) may be performed by the controller outputting a control signal to either or both thereof. The control signal may be a Boolean control signal for the switch, and the control signal to the variable resistor or potentiometer may be a value to control the level of electrical signal to output therefrom.

The electronics may further be configured to receive peak energy usage data indicative of an amount of electrical power cumulatively being drawn by local region of customers, and, responsive to determining that the peak energy usage data is above a threshold level, which may be stored in the memory and used by the processor(s), reduce or stop electrical power from being drawn therefrom. The controller may use the peak energy usage data to determine whether or not to alter the electrical power being supplied to the EV. The electronics may further be configured to automatically request the peak demand usage data, and, in response to determining that the data is at or below the threshold level, enable the electrical power to be supplied to the EV. A user interface accessible via the electronic display may be configured to enable a user to switch the high-power electrical switch between the ON state and the OFF state. Alternatively, the user interface may be located on a mobile device via an app or website. Still yet, the user interface may be accessible via a hub of an alarm system local to the adapter and that may be used to alter operation of the adapter.

The user interface may enable the user to set an amount of money to be used in powering the EV during a charging session. The electronics may further be configured to automatically access a current price of electricity being paid by the user. The electronics may further be configured to communicate via a local communications channel directly with a wireless device, and, responsive to receiving a command from the wireless device, transition the high-voltage electrical switch between the ON state and the OFF state. The electronics may further be configured to access a data repository that includes current peak electricity demand of an electricity energy provider serving a location at which the EV is being charged, and responsive to determining that the current peak electricity demand is at or above a threshold level, reduce or stop electricity being output via the electrical cable to the EV.

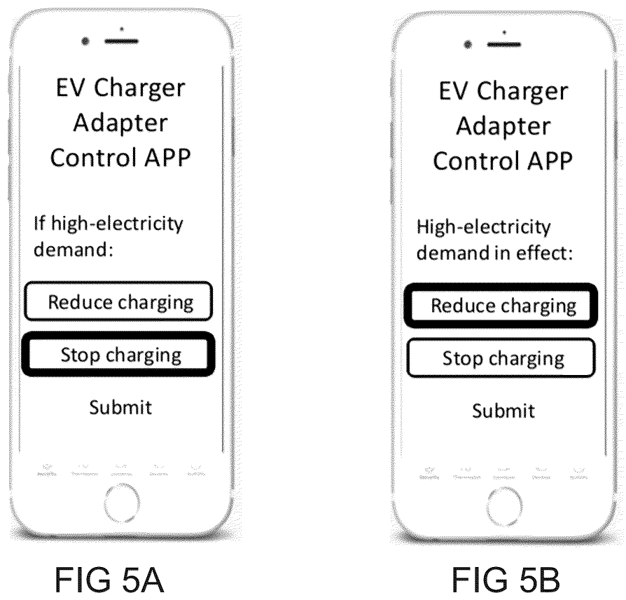

With regard to FIGS. 5A and 5B, illustrations of an illustrative user interface that enables a user to set up automatic control by the adapter via a mobile app (FIG. 5A) and semi-automatic control by the adapter via the mobile app (FIG. 5B) are shown. As shown in FIG. 5A, the mobile app may enable a user to set the adapter to automatically stop charging in the event that a utility provider determines that high-electricity demand on an electricity grid on which the adapter is connected. The mobile app may communicate a parameter that is stored by the adapter, and responsive the mobile app receiving a notification from the energy provider that a high-electricity demand is in effect, a notification may be communicated to the adapter for control thereof. As shown in FIG. 5B, in response to the mobile app receiving a notification that a high-electricity situation is in effect from the electricity provider, the user may be prompted to select whether to reduce or stop charging the EV. In an embodiment, the user may ignore or actively reject altering charging of the EV via the adapter. It should be understood that the same or similar user interfaces may be provided by a hub of an alarm system at a home or other building at which the EV is being charged.

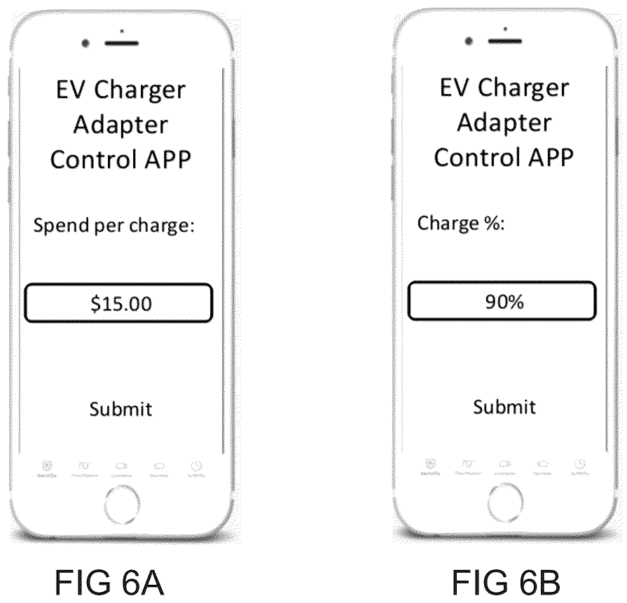

With regard to FIGS. 6A and 6B, illustrations of illustrative user interfaces that enables a user to submit how much or a maximum amount of money to spend in charging a rechargeable battery of an EV (FIG. 6A) and/or what percentage of charge to charge the rechargeable battery (FIG. 6B) are shown. An electronic device on which the user interface is using may communicate the amount of money or percentage to an adapter for storing thereby and using during a recharging session. The adapter may access energy prices and monitor amount of energy being consumed to determine amount of money. The adapter may communicate with the EV to determine percentage of charge of the rechargeable battery such that the controller may control electricity being output by the adapter for recharging the rechargeable battery.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. An electric vehicle charger adapter, comprising:
a housing;
electronics disposed within the housing;
a high-voltage electrical switch in electrical communication with the electronics, and configured to switch between an ON state and an OFF state in response to a control signal output by the electronics to the electrical switch;
at least one electrical connector connected to the housing and adapted to be plugged into respective at least one reciprocal power outlet, the at least one electrical connector being in electrical communication with a first side of the electrical switch;
an electrical cable electrically connected to a second side of the electrical switch; and
a charging plug physically and electrically connected to the electrical cable, and adapted to be plugged into a charging socket of an electric vehicle (EV).

2. The adapter according to claim 1, wherein the electronics include a radio configured to wirelessly communicate with a local area network (LAN).

3. The adapter according to claim 2, wherein the LAN is a Wi-Fi communications network, and wherein the electronics are further configured to communicate with a hub of an alarm system locally positioned at a residence at which the electrical outlet is located.

4. The adapter according to claim 1, wherein the electronics include a radio configured to wirelessly communicate with a wide area network (WAN).

5. The adapter according to claim 4, wherein the electronics are configured to sense electrical power being drawn from the EV and communicate data indicative of an amount of electrical power being drawn to an electronic device via the WAN.

6. The adapter according to claim 5, wherein the electronics are configured to reduce or stop electrical power being drawn by the EV in response to a command received from an electronic device via the WAN.

7. The adapter according to claim 4, wherein the electronics are further configured to receive peak energy usage data indicative of an amount of electrical power cumulatively being drawn by local region of customers, and, responsive to determining that the peak energy usage data is above a threshold level, reduce or stop electrical power from being drawn therefrom.

8. The adapter according to claim 7, wherein the electronics are further configured to automatically request the peak energy usage data, and, in response to determining that the data is at or below the threshold level, enable the electrical power to be supplied to the EV.

9. The adapter according to claim 1, further comprising a user interface configured to enable a user to switch the high-voltage electrical switch between the ON state and the OFF state.

10. The adapter according to claim 8, further comprising a user interface that enables the user to set an amount of money to be used in powering the EV during a charging session.

11. The adapter according to claim 9, wherein the electronics are further configured to automatically access a current price of electricity being paid by the user.

12. The adapter according to claim 1, wherein the electronics are further configured to:
communicate via a local communications channel directly with a wireless device; and
responsive to receiving a command from the wireless device, transition the high-voltage electrical switch between the ON state and the OFF state.

13. The adapter according to claim 1, wherein the electronics are further configured to:
access a data repository that includes current peak electricity demand of an electricity energy provider serving a location at which the EV is being charged; and
responsive to determining that the current peak electricity demand is at or above a threshold level, reduce or stop electricity being output via the electrical cable to the EV.

14. A method of manufacturing an electric vehicle charger adapter, comprising:
positioning electronics within a housing;
electrically connecting a high-voltage electrical switch with the electronics, the high-voltage electrical switch configured to switch between an ON state and an OFF state in response to a control signal output by the electronics to the electrical switch;
connecting at least one electrical connector to the housing, the at least one electrical connector adapted to be plugged into respective at least one reciprocal power outlet;
electrically connecting the electrical connector with a first side of the electrical switch;
electrically connecting an electrical cable to a second side of the electrical switch; and
physically and electrically connecting a charging plug to the electrical cable, the charging plug adapted to be plugged into a charging socket of an electric vehicle (EV).

15. The method according to claim 14, wherein positioning electronics includes positioning a radio configured to wirelessly communicate with a local area network (LAN).

16. The method according to claim 14, wherein positioning a radio includes positioning a radio configurable to communicate with a hub of an alarm system locally positioned at a residence at which the electrical outlet is located.

17. The method according to claim 14, wherein the electronics include a radio configured to wirelessly communicate with a wide area network (WAN).

18. The method according to claim 17, further comprising:
sensing electrical power being drawn from the EV; and
communicating data indicative of an amount of electrical power being drawn to an electronic device via the WAN.

19. The method according to claim 17, further comprising reducing or stopping electrical power being drawn by the EV in response to a command received from an electronic device via the WAN.

20. The method according to claim 14, further comprising:
receiving peak energy usage data indicative of an amount of electrical power cumulatively being drawn by local region of customers; and
responsive to determining that the peak energy usage data is above a threshold level, reducing or stopping electrical power from being drawn therefrom.

21. The method according to claim 20, further comprising:
automatically requesting the peak energy usage data; and
in response to determining that the data is at or below the threshold level, enabling the electrical power to be supplied to the EV.

22. The method according to claim 14, further comprising enabling a user to switch the high-voltage electrical switch between the ON state in the OFF state.

23. The method according to claim 14, further comprising enabling a user to set an amount of money to be used in powering the EV during a charging session.

24. The method according to claim 23, further comprising automatically accessing a current price of electricity being paid by the user.

25. The method according to claim 14, further comprising:
communicating via a local communications channel directly with a wireless device; and
responsive to receiving a command from the wireless device, transitioning the high-voltage electrical switch between the ON state and the OFF state.

26. The method according to claim 14, further comprising:
accessing a data repository that includes current peak electricity demand of an electricity energy provider serving a location at which the EV is being charged; and
responsive to determining that the current peak electricity demand is at or above a threshold level, reducing or stopping electricity being output via the electrical cable to the EV.
